(19) United States
(12) Patent Application Publication
(10) Pub. No.: US 2012/0041820 A1
(43) Pub. Date: Feb. 16, 2012

(54) MACHINE TO STRUCTURE DATA AS COMPOSITE PROPERTY

(76) Inventors: Mark Allen Simon, San Jose, CA (US); Suresh Sagiraju, San Jose, CA (US); Shane Shew-Shin Yong, Fremont, CA (US); Hua Chen, San Jose, CA (US); Zhenyin Yang, Saratoga, CA (US)

(21) Appl. No.: 12/855,659

(22) Filed: Aug. 12, 2010

(51) Int. Cl. G06F 17/30; G06Q 30/00

(52) U.S. Cl. 705/14.49; 707/803; 707/741; 707/E17.005; 707/769; 707/E17.002; 707/E17.014

(57) ABSTRACT

Information pertinent to an item or product may be organized (e.g., structured) as a property of the item or product. The property may be represented (e.g., stored) as property data in a data structure of the item or product. A property may have one or more properties of its own. In this manner, information pertinent to items, products, properties, or any suitable combination thereof may be structured with any level of sophistication or complexity. Accordingly, a data structure may be generated to contain one or more properties of an item or product, as well as to contain one or more properties of those properties. A “composite property” refers to such a data structure and may be indexed based on a value contained therein. The value may be used to identify the item or the product, for example, as an instance of a virtual product.

### TECHNICAL FIELD

The subject matter disclosed herein generally relates to the processing of data. Specifically, the present disclosure addresses systems and methods of structuring data as a composite property.

### BACKGROUND

Nowadays, a machine (e.g., a computing device) may be used to process information pertaining to items and products. As an example, a machine may host a database that tracks an inventory of items, which may be specimens of products. The machine may be all or part of a network-based system for processing such information. For example, a network-based commerce system may include one or more machines that maintain a database, where records in the database contain information pertinent to various items or products. The various items or products may be available for purchase, and accordingly may be merchandised or advertised as being so available.

As used herein, the term “product” may include a tangible product, an intangible product (e.g., downloadable electronic data), an obligation to provide a product, a service, a license to use a service, or any suitable combination thereof. An “item” herein refers to an instance of a product (e.g., a specimen of the product). While a single item may constitute a product (e.g., a unique one-of-a-kind item cataloged as a product), in many cases multiple items constitute multiple instances of a product. For example, a product may be a particular model of digital camera, while a specific digital camera of that model (e.g., having a unique serial number) may be an item constituting an instance of that product.

### BRIEF DESCRIPTION OF THE DRAWINGS

Some embodiments are illustrated by way of example and not limitation in the figures of the accompanying drawings in which:

FIG. 1-4 are conceptual diagrams illustrating relationships among an item, a characteristic of the item, a descriptor of the characteristic, and a feature of the descriptor, according to some example embodiments;

FIG. 5 is a conceptual diagram illustrating properties that are directly or indirectly related to a product, according to some example embodiments;

FIG. 6 is a network diagram illustrating a system that includes a data structure machine, according to some example embodiments;

FIG. 7 is a block diagram illustrating a data structure usable as a composite property, according some example embodiments;

FIG. 8 is a block diagram illustrating components of a data structure machine, according to some example embodiments;

FIG. 9-12 are flowcharts illustrating a method of structuring data as a composite property of an item, according to some example embodiments; and

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems described herein are directed to structuring data as a composite property. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Information pertinent to an item or product may be organized (e.g., structured) as a property of the item or product. The property may be represented (e.g., stored) as property data in a data structure of the item or product. For example, the property may be represented in a listing that describes the item or product, or in a database record that stores information regarding the item or product. In many cases, property data takes the form of an attribute-value pair. An attribute-value pair includes an attribute of the item or product and a corresponding value of the attribute. Generally, in a valid attribute-value pair, the value is assignable to the attribute and may be one of multiple potential values that are assignable to the attribute. For example, an attribute-value pair may be expressed as “color=red,” where allowable colors include “red,” “yellow,” and “blue.” The attribute is “color,” and its corresponding value is “red.” The words “red,” “yellow,” and “blue” are values that are assignable to the attribute, and the word “red” is the value actually assigned to the attribute. As another example, an attribute-value pair may be expressed as “color=0x1f,” where “0x1f” is a reference (e.g., an identifier or a pointer) that specifies the color “red.” As a further example, an attribute-value pair may be expressed as “comment=‘I really like this digital camera because it took the best outdoor shots while I was on my vacation to New Zealand,” where the attribute is “comment” and the value is free-form text (e.g., a sentence or a paragraph).

Similarly, information pertinent to a property may also be organized as a “property of a property.” Stated another way, a property may have one or more properties of its own. In particular, the value of an attribute-value pair may correspond to its own property data, which may include a further attribute-value pair. For example, where an attribute-value pair for a digital camera is “color=red,” an attribute-value pair for the color “red” may be “earliest availability=available now.” As further examples, the attribute-value pair for the color “red” may be “earliest availability=available in 90 days” or “earliest availability=Oct. 1, 2010.”

Moreover, information may be organized as a “property of a property of an item” or a “property of a property of a property of a product.” As used herein, the terms “characteristic,” “descriptor,” and “feature” all refer to a property and are used as synonyms of the term “property.” For clarity, a “property of a property of a property of an item” may be described as a “feature of a descriptor of a characteristic of an item.” In this manner, information pertinent to items, products, properties, or any suitable combination thereof may be structured with any level of sophistication or complexity (e.g., beyond three steps removed from an item or product). Accordingly, a data structure may be generated (e.g., by a machine) to contain one or more properties of an item or product, as well as to contain one or more properties of those properties. In the discussion herein, a “composite property” refers to such a data structure. Generally, a composite property may correspond to an item, a product, another composite property, or any suitable combination thereof.

A composite property (e.g., of an item or a product) may be indexed based on any value contained therein, and that value may be used to identify the item or the product (e.g., in response to a search request based on that value). Continuing the above example, suppose the composite property of a digital camera contains the attribute-value pair “color=red.” A query for red digital cameras may result in identification of this digital camera. Furthermore, suppose the composite property for the digital camera includes the attribute-value pair “earliest availability=available now.” A query for presently available digital cameras may result in identification of this digital camera.

As a result, a composite property may be used to identify an item as an instance of a virtual product. A “virtual product,” as used herein, is a set of items that share at least one attribute-value pair within their respective composite properties. Thus, following the previous example, although an item may be an instance of a particular product (e.g., serial number 00010 of a Model ABC digital camera), the same item may also be instances of multiple virtual products (e.g., all digital cameras that are red, all digital cameras that are available now, and all digital cameras that are both red and available now). Moreover, a composite property may be used to identify a virtual product as being related to another product, virtual or otherwise. For example, where one product has a composite property with the attribute-value pair “manufacturer=Sony,” a related virtual product may have a composite property with the attribute-value pair “nationality of manufacturer=Japan.”

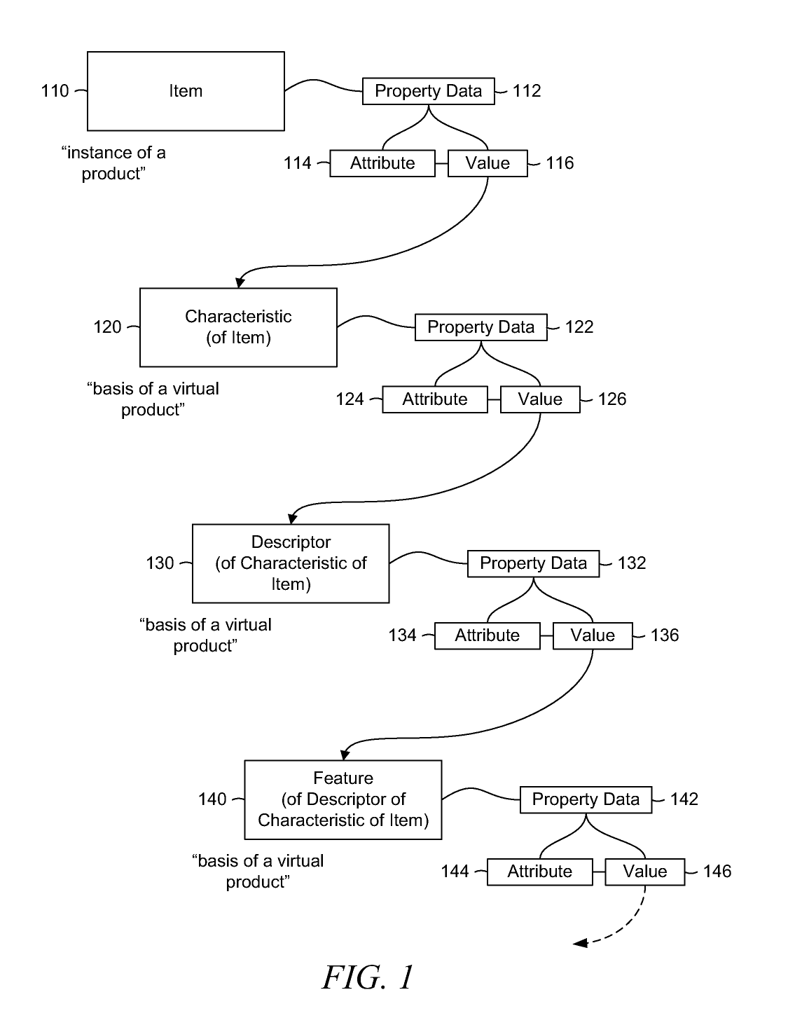

FIG. 1-4 are conceptual diagrams illustrating relationships among an item 110, a characteristic 120 of the item 110, a descriptor 130 of the characteristic 120, and a feature 140 of the descriptor 130, according to some example embodiments.

As shown in FIG. 1, the item 110 is an instance of a product and corresponds to property data 112. The property data 112 specifies an attribute 114 of the item 110. The property data 112 also specifies a value 116 of the attribute 114, thus specifying an attribute-value pair pertinent to the item 110. The value 116 specifies the characteristic 120 of the item 110.

The characteristic 120 is a basis of a virtual product and corresponds to property data 122. The property data 122 specifies an attribute 124 of the characteristic 120. The property data 122 also specifies a value 126 of the attribute 124, thereby specifying an attribute-value pair pertinent to the characteristic 120. The value 126 specifies the descriptor 130 of the characteristic 120.

The descriptor 130 is also a basis of a virtual product and corresponds to property data 132. The property data 132 specifies an attribute 134 of the descriptor 130. The property data 132 also specifies a value 136 of the attribute 134, thereby specifying an attribute-value pair pertinent to the descriptor 130. The value 136 specifies the feature 140 of the descriptor 130.

The feature 140 is another basis of a virtual product and corresponds to property data 142. The property data 142 specifies an attribute 144 of the feature 140. The property data 142 also specifies a value 146 of the attribute 144, thereby specifying an attribute-value pair pertinent to the feature 140. The value 146 may specify a downstream property (not shown) of the feature 140. This chain of relationships may extend to any length and, in some example embodiments, may include one or more circular relationships (e.g., direct or indirect loopback relationships). As noted above, any level of sophistication or complexity may be supported by a composite property.

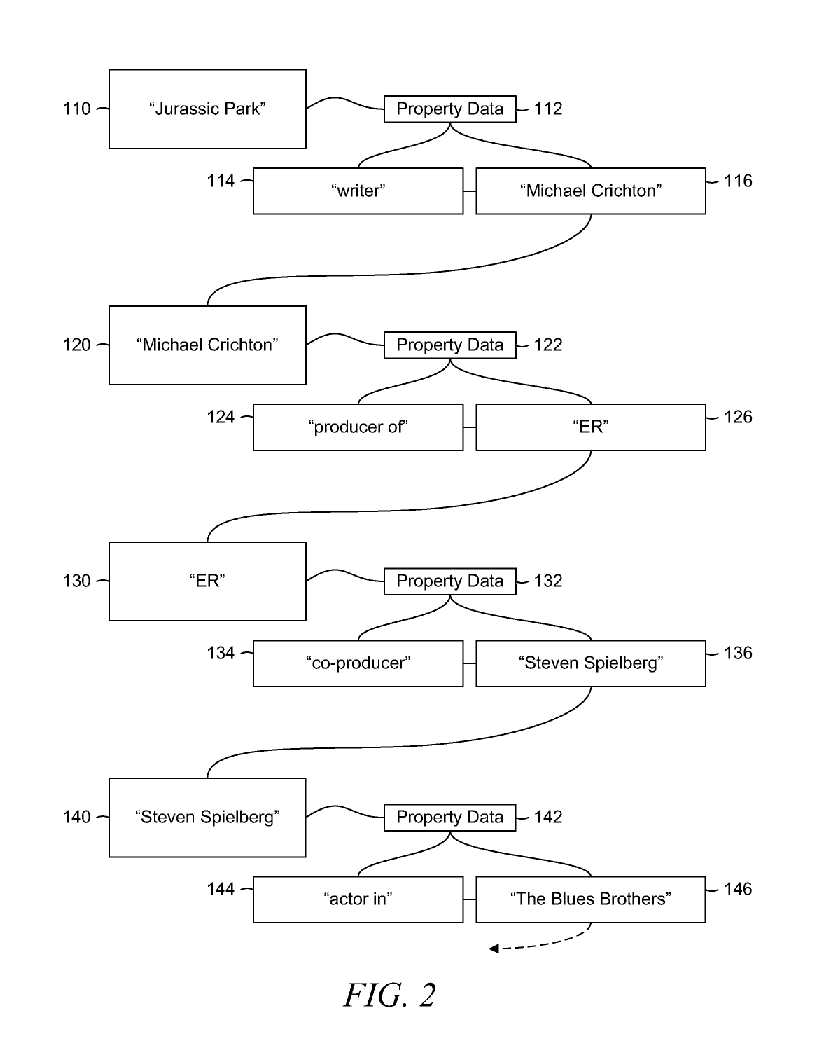

In an example embodiment shown in FIG. 2, the item 110 is an instance (e.g., a DVD copy) of a movie titled “Jurassic Park.” The attribute 114 of the item 110 is “writer,” and the corresponding value 116 is “Michael Crichton.”Accordingly, a query for “writer: Michael Crichton” may result in identification (e.g., as instances of a virtual product) of items of which Michael Crichton is a writer (e.g., the movie “Jurassic Park” and the book “Congo”). Hence, a virtual product based on “Michael Crichton” may be a product that is related to “Jurassic Park.”

The characteristic 120 of the item 110, as specified by the value 116, is “Michael Crichton.” The attribute 124 of the characteristic 120 is “producer of,” and the corresponding value 126 is “ER” (the title of a television show). Accordingly, a query for “producer of: ER” may result in identification (e.g., as instances of a virtual product) of items for which Michael Crichton is a producer (e.g., the show “ER” and the movie “Twister”). Hence, a virtual product based on “ER” may be a product that is related to “Michael Crichton,” “Jurassic Park,” or both.

The descriptor 130 of the characteristic 120, as specified by the value 126, is “ER.” The attribute 134 of the descriptor 130 is “co-producer,” and the corresponding value 136 is “Steven Spielberg.” Accordingly, a query for “co-producer: Steven Spielberg” may result in identification (e.g., as instances of a virtual product) of items for which Steven Spielberg is a co-producer (e.g., the show “ER” and the movie “The Goonies”). Hence, a virtual product based on “Steven Spielberg” may be a product that is related to “ER,” “Michael Crichton,” “Jurassic Park,” or any suitable combination thereof.

The feature 140 of the descriptor 130, as specified by the value 136, is “Steven Spielberg.” The attribute 144 of the feature 140 is “actor in,” and the corresponding value 146 is “The Blues Brothers.” Accordingly, a query for “actor in: The Blues Brothers” may result in identification (e.g., as instances of a virtual product) of items in which Steven Spielberg is an actor (e.g., the movie “The Blues Brothers” and the movie “Vanilla Sky”). Hence, a virtual product based on “The Blues Brothers” may be a product that is related to “Steven Spielberg,” “ER,” “Michael Crichton,” “Jurassic Park,” or any suitable combination thereof.

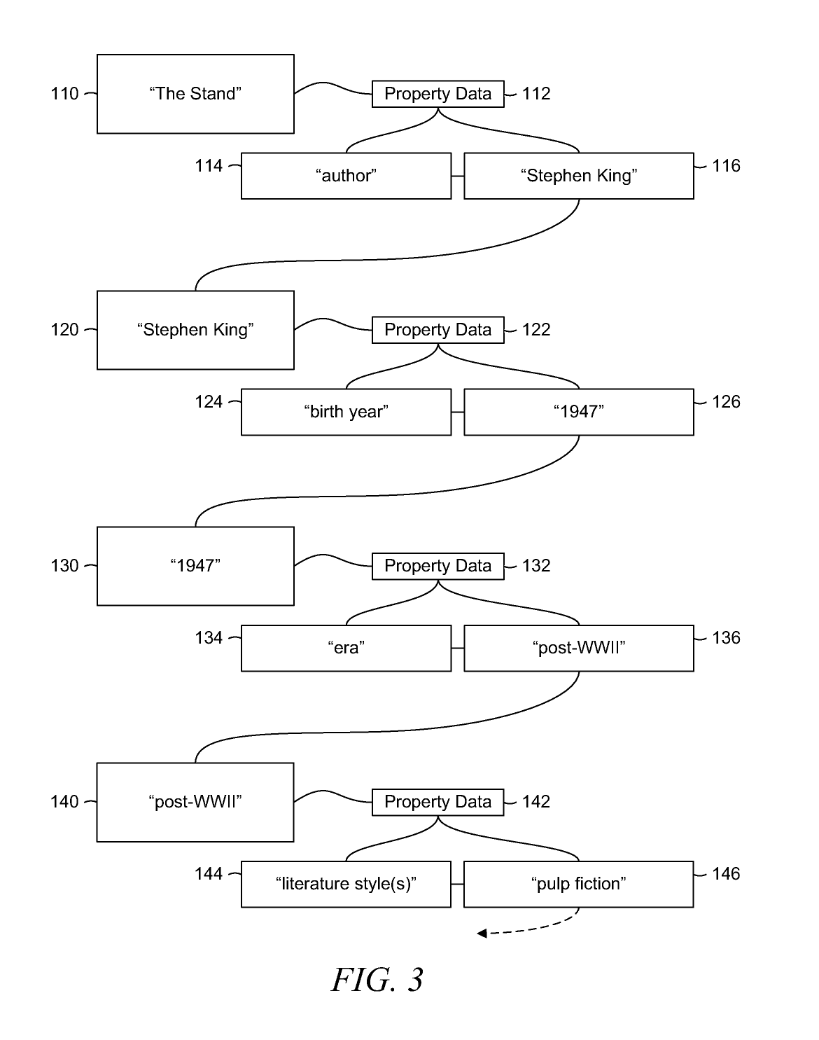

In an example embodiment shown in FIG. 3, the item 110 is an instance (e.g., a printed copy) of a book titled “The Stand.” The attribute 114 of the item 110 is “author,” and the corresponding value 116 is “Stephen King.” Accordingly, a query for “author: Stephen King” may result in identification of items of which Stephen King is an author (e.g., the book “The Stand” and the book “Pet Sematary”). Hence, a virtual product based on “Stephen King” may be a product that is related to “The Stand.”

The characteristic 120 of the item 110, as specified by the value 116, is “Stephen King.” The attribute 124 of the characteristic 120 is “birth year,” and the corresponding value 126 is “1947.” Accordingly, a query for “birth year: 1947” may result in identification of items that are related to a person born in 1947 (e.g., a book by Stephen King and a song by David Bowie). Hence, a virtual product based on “1947” may be a product that is related to “Stephen King,” “The Stand,” or both.

The descriptor 130 of the characteristic 120, as specified by the value 126, is “1947.” The attribute 134 of the descriptor 130 is “era,” and the corresponding value 136 is “post-WWII.” Accordingly, a query for “era: post-WWII” may result in identification of items that are related to a period of time between 1946 and 1960 (e.g., a book by Richard Matheson and a film by Alfred Hitchcock). Hence, a virtual product based on “post-WWII” may be a product that is related to “1947,” “Stephen King,” “The Stand,” or any suitable combination thereof.

The feature 140 of the descriptor 130, as specified by the value 136, is “post-WWII.” The attribute 144 of the feature 140 is “literature style(s),” and the corresponding value 146 is “pulp fiction.” Accordingly, a query for “literature style(s): pulp fiction” may result in identification of items for which the literature style is pulp fiction (e.g., books by Frank Herbert and books by H. P. Lovecraft). Hence, a virtual product based on “pulp fiction” may be a product that is related to “post-WWII,” “1947,” “Stephen King,” “The Stand,” or any suitable combination thereof.

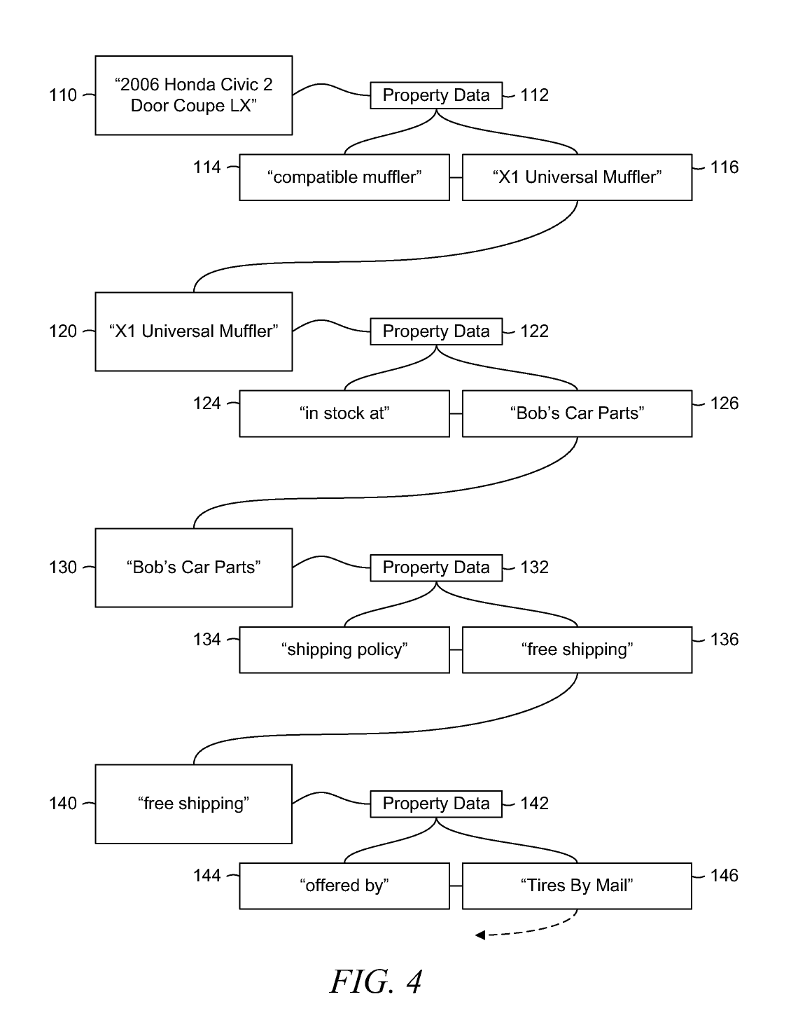

In an example embodiment shown in FIG. 4, the item 110 is an instance (e.g., a representative instance) of a car, specifically, a “2006 Honda Civic 2 Door Coupe LX.” The attribute 114 of the item 110 is “compatible muffler,” and the corresponding value 116 is “X1 Universal Muffler.” Accordingly, a query for “compatible muffler: X1 Universal Muffler” may result in identification of items with which the X1 Universal Muffler is compatible. Hence, a virtual product based on “X1 Universal Muffler” may be a product that is related to “2006 Honda Civic 2 Door Coupe LX.”

The characteristic 120 of the item 110, as specified by the value 116, is “X1 Universal Muffler.” The attribute 124 of the characteristic 120 is “in stock at,” and the corresponding value 126 is “Bob's Car Parts.” Accordingly, a query for “in stock at: Bob's Car Parts” may result in identification of items that are in stock at Bob's Car Parts (e.g., an X1 Universal Muffler and a dashboard cover).

The descriptor 130 of the characteristic 120, as specified by the value 126, is “Bob's Car Parts.” The attribute 134 of the descriptor 130 is “shipping policy,” and the corresponding value 136 is “free shipping.” Accordingly, a query for “shipping policy: free shipping” may result in identification of items for which shipping is free (e.g., a X1 Universal Muffler and a set of snow tires). Hence, a virtual product based on “free shipping” may be a product that is related to “Bob's Car Parts,” “X1 Universal Muffler,” “2006 Honda Civic 2 Door Coupe LX,” or any suitable combination thereof.

The feature 140 of the descriptor 130, as specified by the value 136, is “free shipping.” The attribute 144 of the feature 140 is “offered by,” and the corresponding value 146 is “Tires By Mail.” Accordingly, a query for “offered by: Tires By Mail” may result in identification of items that are offered by Tires By Mail (e.g., a set of snow tires and a set of racing tires). Hence, a virtual product based on “Tires By Mail” may be a product that is related to “free shipping,” “Bob's Car Parts,” “X1 Universal Muffler,” “2006 Honda Civic 2 Door Coupe LX,” or any suitable combination thereof.

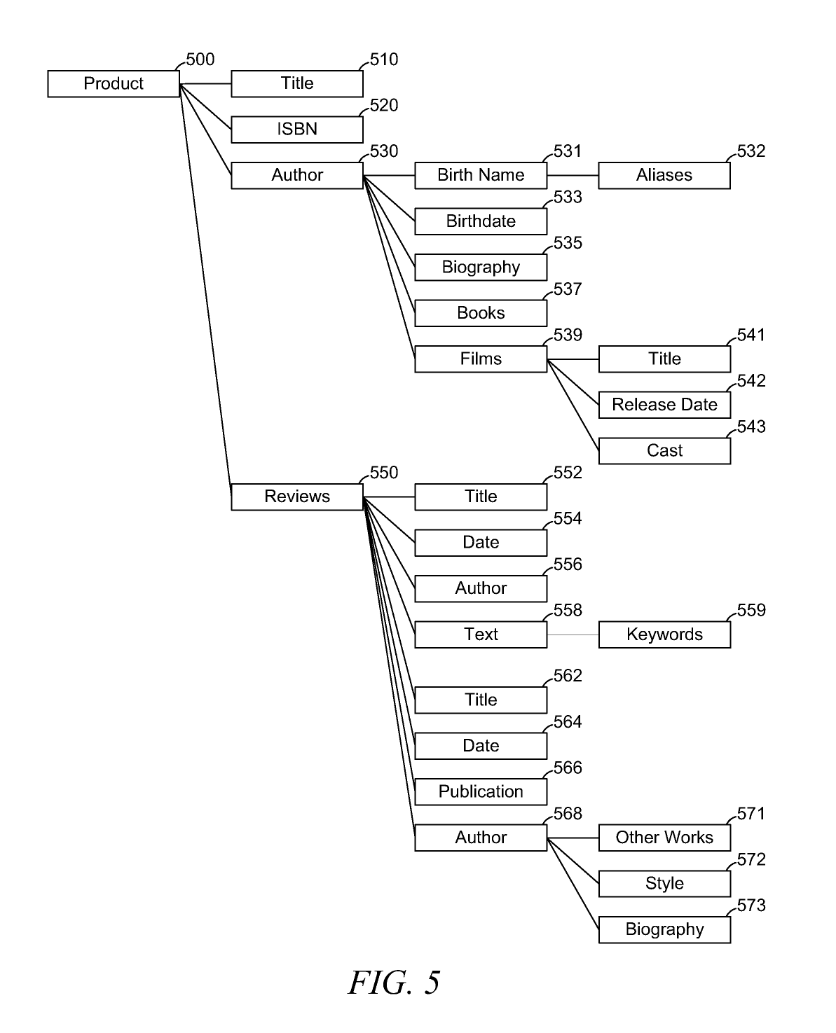

FIG. 5 is a conceptual diagram illustrating properties 510-573 that are directly or indirectly related to a product 500, according to some example embodiments. Each of the properties 510-573 is named after an attribute specified by property data corresponding to that property. As an example, the product 500 may be a media item (e.g., a video, a book, or audio data). As shown in FIG. 5, the product 500 has four properties 510 (“Title”), 520 (“ISBN”), 530 (“Author”), and 550 (“Reviews”). These directly related properties 510, 520, 530, and 550 may be designated as “characteristics” of the product 500, using the nomenclature of FIG. 1-4.

The property 530 (“Author”) has its own properties 531 (“Birth Name”), 533 (“Birthdate”), 535 (“Biography”), 537 (“Books”), and 539 (“Films”). Likewise, the property 550 (“Reviews”) has its own properties 552 (“Title”), 554 (“Date”), 556 (“Author”), 558 (“Text”), 562 (“Title”), 564 (“Date”), 566 (“Publication”), and 568 (“Author”). The properties 531, 533, 535, 537, 539, 552, 554, 556, 558, 562, 564, 566, and 568 constitute “properties of properties” and may be designated as “descriptors” of “characteristics” of the product 500, using the nomenclature of FIG. 1-4. Note that these “properties of properties” have an indirect relationship to the product 500 and need not refer to the product 500.

The property 531 (“Name”) has its own property 532 (“Aliases”). Similarly, the property 539 (“Films”) has its own properties 541 (“Title”), 542 (“Release Date”), and 543 (“Cast”). The property 558 (“Text”) has its own property 559 (“Keywords”), and the property 568 (“Author”) has its own properties 571 (“Other Works”), 572 (“Style”), and 573 (“Biography”). The properties 532, 541, 542, 543, 559, 571, 572, and 573 constitute “properties of properties of properties” and may be designated as “features” of “descriptors” of “characteristics” of the product 500, using the nomenclature of FIG. 1-4. Note that these “properties of properties of properties” have an indirect relationship to the product 500 and need not refer to the product 500.

The relationships among these properties 510-573 may be represented in a data structure as a composite property, which may be stored as a composite property of the product 500. This may have the effect of organizing (e.g., structuring) data that otherwise would be unstructured with respect to the product. For example, suppose that the author of the product 500 used a fictitious name (e.g., a nom de plume) for the product 500, but has a legal birth name specified in the property 531 and a list of known aliases (e.g., nicknames) specified in the property 532. While a vendor of the product 500 may neglect to provide the legal birth name or the aliases (e.g., due to limited space on packaging for the product 500), the legal birth name and the aliases may be available from an alternative source of information (e.g., another vendor of the product, the manufacturer of the product, or an information service).

A machine (e.g., a data structure machine) may generate the composite property to include all this information. The machine may then index the composite property based on any one or more of the properties 510-573, thereby enabling identification of the product 500 using any one or more of the properties 510-573 (e.g., in response to a query submitted by a user). Furthermore, the machine may identify multiple products (e.g., multiple items from multiple products) as a single virtual product, based on any one or more of the properties 510-573 being respectively contained in composite properties of the multiple products. In other words, meaningful relationships (e.g., commonalities) among products may be identified through “properties of properties” of those products.

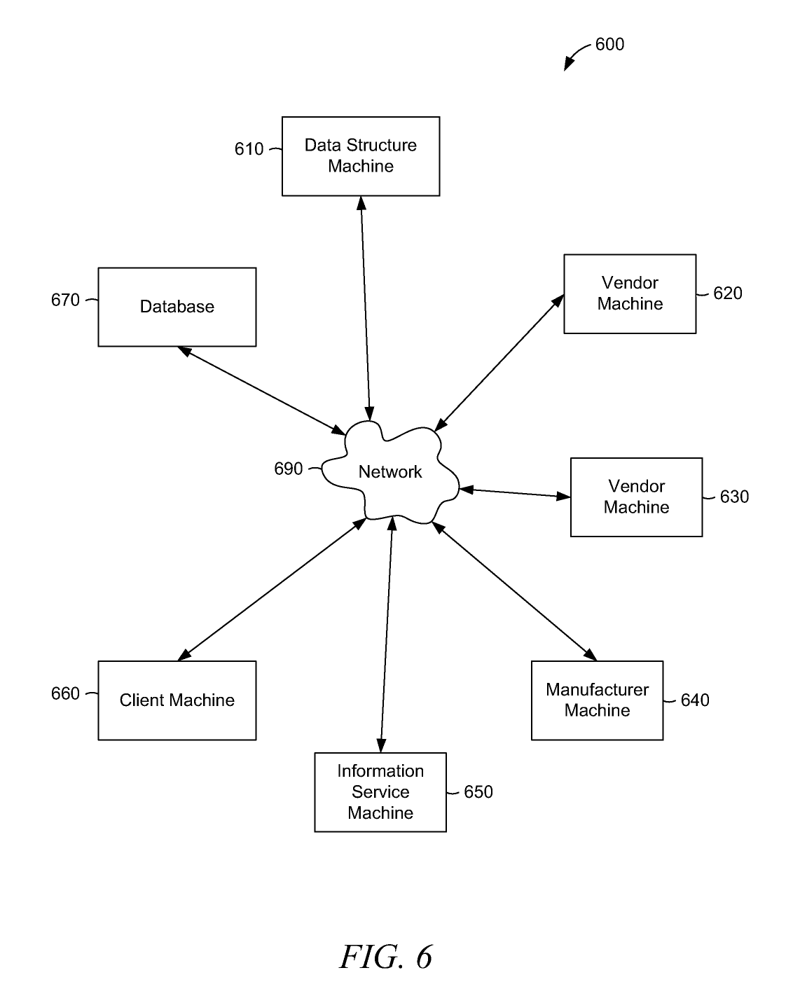

FIG. 6 is a network diagram illustrating a system 600 that includes a data structure machine 610, according to some example embodiments. The system 600 includes the data structure machine 610, vendor machines 620 and 630, a manufacturer machine 640, an information service machine 650, a client machine 660, and a database 670, all coupled to each other via a network 690.

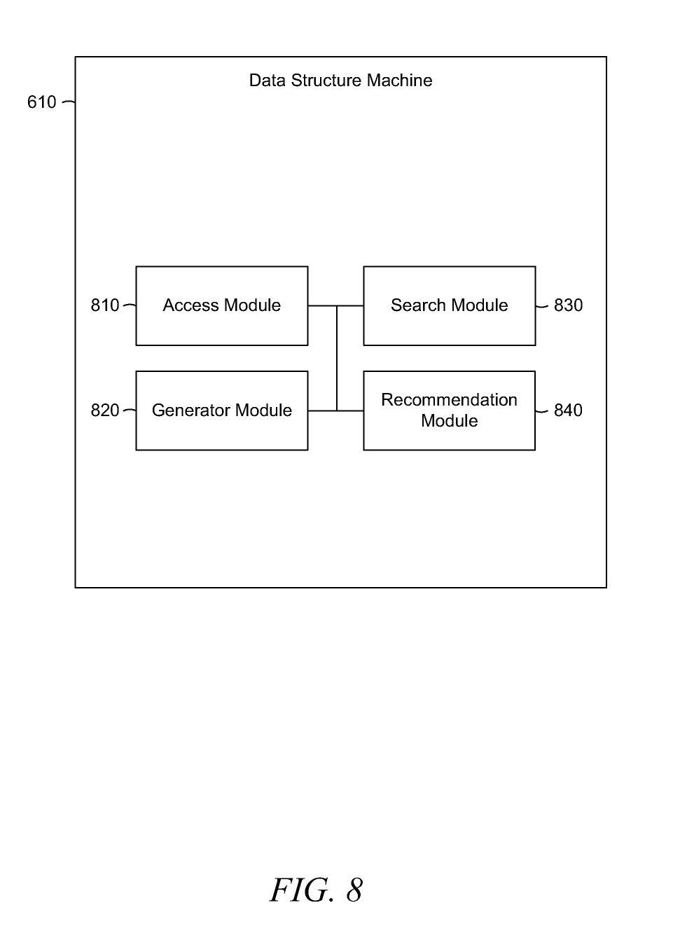

The data structure machine 610 and the database 670 may be associated with a network-based commerce system and accordingly may form all or part of such a network-based commerce system. The data structure machine 610 is configured to generate a data structure as a composite property for the item 110, as discussed in greater detail below with respect to FIG. 8-12. The vendor machines 620 and 630 correspond to different vendors (e.g., sellers) of the item 110. Each of the vendor machines 620 and 630 may provide information usable by the data structure machine 610 to generate one or more properties (e.g., property data). Thus, generation of the data structure may include generating one or more attribute-value pairs based on information received from the different vendor machines 620 and 630. Similarly, information usable by the data structure machine 610 to generate one or more properties may be received from the manufacturer machine 640, the information service machine 650, or any suitable combination thereof. In various example embodiments, the client machine 660 may submit information usable by the data structure machine 610 to generate one or more properties. For instance, following the example shown in FIG. 2, a user of the client machine 660 may upload an interesting fact about Michael Crichton for inclusion in the property data 122 of the characteristic 120 (“Michael Crichton”).

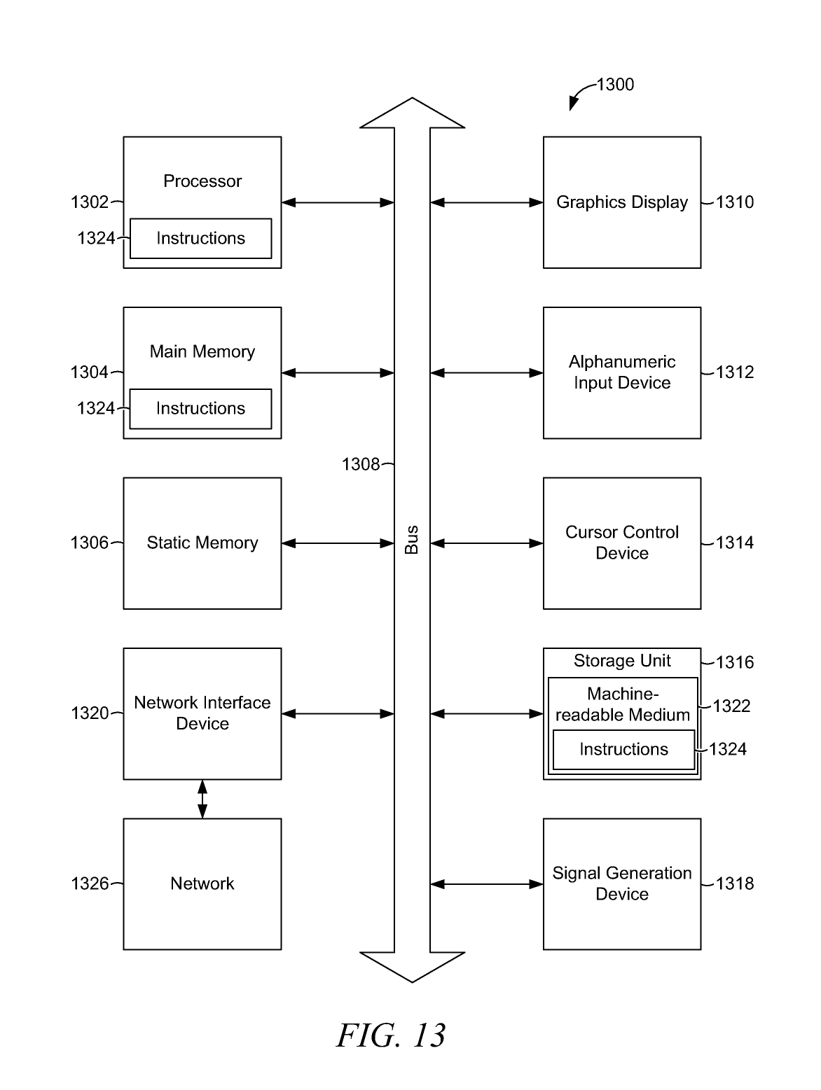

Any of the machines shown in FIG. 6 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 13. Moreover, unless specifically stated otherwise, any two or more of the machines illustrated in FIG. 6 may be combined into a single machine, and the functions described herein for any single machine may be subdivided among multiple machines.

The database 670 may be any kind of database that stores information (e.g., a data structure stored as one or more data records). For example, the database 670 may be a single file (e.g., a tab-delimited text file), a spreadsheet, a relational database, a triple-store, or any suitable combination thereof. Moreover, the database 670 may be implemented by one or more machines, which may be co-located together (e.g., a database server “farm”) or separated in location (e.g., a cloud computing environment).

The network 690 may be any network that enables communication between machines (e.g., data structure machine 610 and client machine 660). For example, the network 690 may be a wired network, a wireless network, or any suitable combination thereof. The network 690 may include one or more portions that constitute a private network, a public network (e.g., the Internet), or any suitable combination thereof.

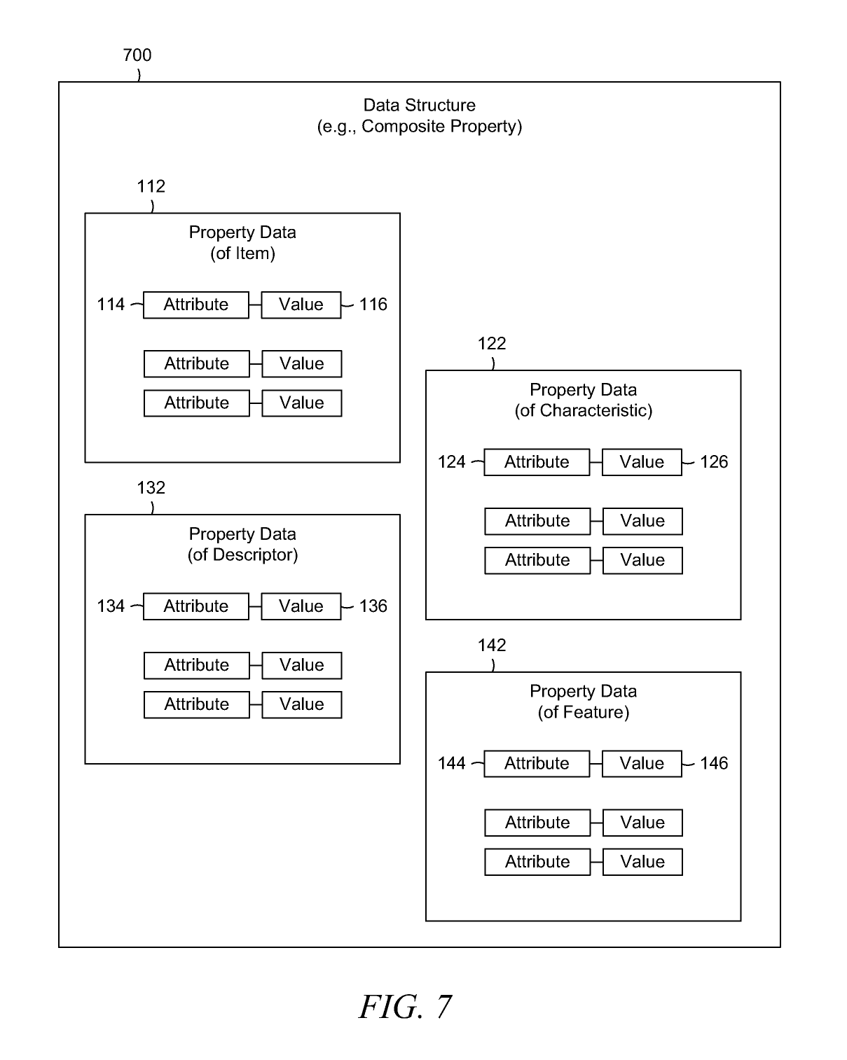

FIG. 7 is a block diagram illustrating a data structure 700 usable as a composite property of the item 110, according to some example embodiments. The data structure 700 may be generated by the data structure machine 610 and stored in the database 670. Included in the data structure 700 are the property data 112 (of the item 110), the property data 122 (of the characteristic 120), the property data 132 (of the descriptor 130), and the property data 142 (of the feature 140).

The property data 112 (of the item 110) includes an attribute-value pair that specifies the attribute 114 and its corresponding value 116. The data structure 700 includes information correlating the value 116 with the property data 122 (of the characteristic 120). For example, the information may be a reference (e.g., a pointer) to the property data 122. Additional attribute-value pairs are also shown.

The property data 122 (of the characteristic 120) includes an attribute-value pair that specifies the attribute 124 and its corresponding value 126. The data structure 700 includes information correlating the value 126 with the property data 132 (of the descriptor 130). For example, the information may be a reference (e.g., a pointer) to the property data 132. Additional attribute-value pairs are also shown.

The property data 132 (of the descriptor 130) includes an attribute-value pair that specifies the attribute 134 and its corresponding value 136. The data structure 700 includes information correlating the value 136 with the property data 142 (of the feature 140). For example, the information may be a reference (e.g., a pointer) to the property data 142. Additional attribute-value pairs are also shown.

The property data 142 (of the feature 140) includes an attribute-value pair that specifies the attribute 144 and its corresponding value 146. The data structure 700 may include information correlating the value 146 with other property data contained in the data structure 700, in another data structure elsewhere, or both. Additional attribute-value pairs are also shown.

FIG. 8 is a block diagram illustrating components of the data structure machine 610, according to some example embodiments. The data structure machine 610 includes an access module 810, a generator module 820, a search module 830, and a recommendation module 840, all configured to communicate with each other (e.g., via a bus, a shared memory, or a switch). Any one or more of these modules may be implemented using hardware or a combination of hardware and software. Moreover, any two or more of these modules may be combined into a single module, and the functions described herein for a single module may be subdivided among multiple modules.

The access module 810 is configured to access various property data (e.g., property data 112, 122, 132, or 142). In various example embodiments, the access module 810 is further configured to receive information usable to generate (e.g., create or modify) one or more properties (e.g., property data 112, 122, 132, or 142). The information may be received, in whole or in part, from different machines (e.g., partially from the vendor machine 620, partially from the vendor machine 630, partially from the manufacturer machine 640, partially from the information service machine 650, and partially from the client machine 660). Accordingly, the access module 810 may receive full or partial updates to the data structure 700, and these updates may be received from one or more sources (e.g., the different machines shown in FIG. 6).

The generator module 820 is configured to generate the data structure 700 based on property data (e.g., property data 112, 122, 132, or 142) accessed by the access module 810. Specifically, the generator module 820 may generate the data structure 700 based on one or more attributes (e.g., attributes 114, 124, 134, or 144) specified by the property data, one or more values (e.g., values 116, 126, 136, or 146) specified by the property data, or any suitable combination thereof. The generator module 820 is further configured to store the data structure 700 in the database 670 as a composite property of the item 110.

Where the access module 810 receives information usable to generate one or more properties (e.g., property data 112, 122, 132, or 142), the generator module 820 is configured to generate one or more properties (e.g., property data 112, 122, 132, or 142) based on the received information. Specifically, the generator module 820 may generate one or more attributes, one or more values, or any suitable combination thereof, based on the received information. Generation of an attribute or a value, as discussed herein, includes modification (e.g., updating) of an existing attribute or value (e.g., already stored in the database 670), as well as creation of a new attribute or value. Accordingly, the generator module 820 may update the data structure 700, in whole or in part, in response to the access module 810 receiving information from one or more sources (e.g., the different machines shown in FIG. 6).

The search module 830 is configured to index the data structure 700 generated by the generator module 820. The search module 830 may index the data structure 700 based on one or more values (e.g., values 116, 126, 136, or 146) specified (e.g., contained) therein. The search module 830 may receive a search request (e.g., in the form of one or more search terms submitted by a user of the client machine 660) and, in response to the search request, perform a query of the database 670 to identify one or more items. The search module 830 may determine that one or more of the values matches (e.g., identically or non-identically) the search request (e.g., matches one or more search terms of the search request) and accordingly identify the item 110 based on the matching value (e.g., value 126, value 136, or value 146).

The recommendation module 840 is configured to identify one or more further items based on the matching value determined by the search module 830. The one or more further items identified by the recommendation module 840 may constitute a virtual product, and the one or more further items may be presented as one or more instances of the virtual product. For example, the recommendation module 840 may transmit a description (e.g., in a listing or in an advertisement) of one of the further items to the client machine 660 for presentation to a user of the client machine 660.

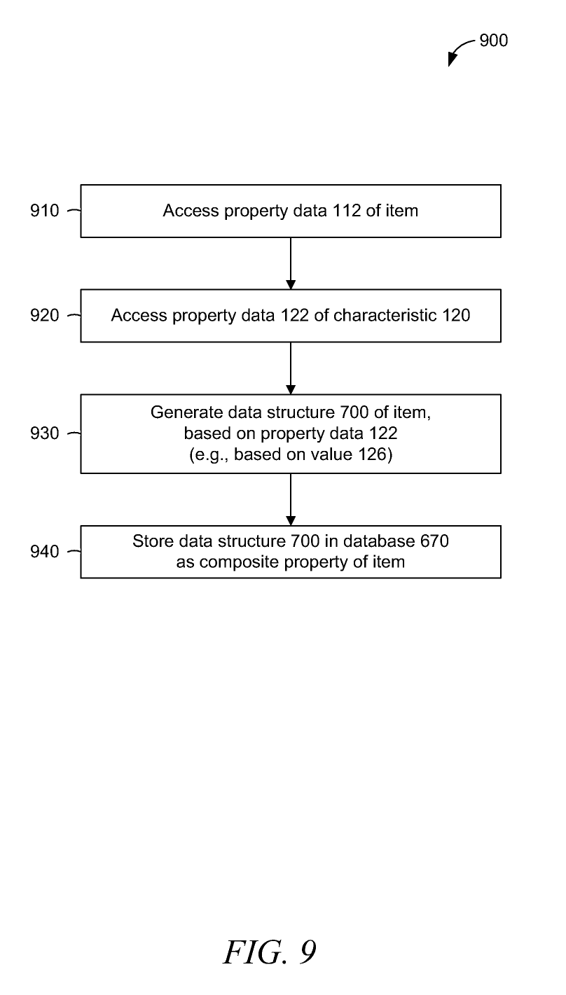

FIG. 9-12 are flowcharts illustrating a method 900 of structuring data as a composite property of the item 110, according to some example embodiments. Operations in the method 900 may be performed by the data structure machine 610, using modules described above with respect to FIG. 8, as appropriate.

As shown in FIG. 9, the method 900 includes operations 910, 920, 930, and 940. In operation 910, the access module 810 accesses the property data 112 of the item 110. The access module 810, in operation 920, accesses the property data 122 of the characteristic 120. In one or both of the operations 910 and 920, accessing property data may include reading information from memory (e.g., a memory of the data structure machine 610), reading information from a database (e.g., database 670), receiving information (e.g., from the vendor machine 620), or any suitable combination thereof.

In operation 930, the generator module 820 generates the data structure 700 based on the property data 122 accessed by the access module 810 in operation 920. For example, the data structure 700 may be generated based on the value 126 specified by the property data 122. The generator module 820 may reference the item 110 in the data structure 700, such that the data structure 700 is a data structure of the item 110. In operation 940, the generator module 820 stores the data structure 700 in the database 670 as a composite property of the item 110.

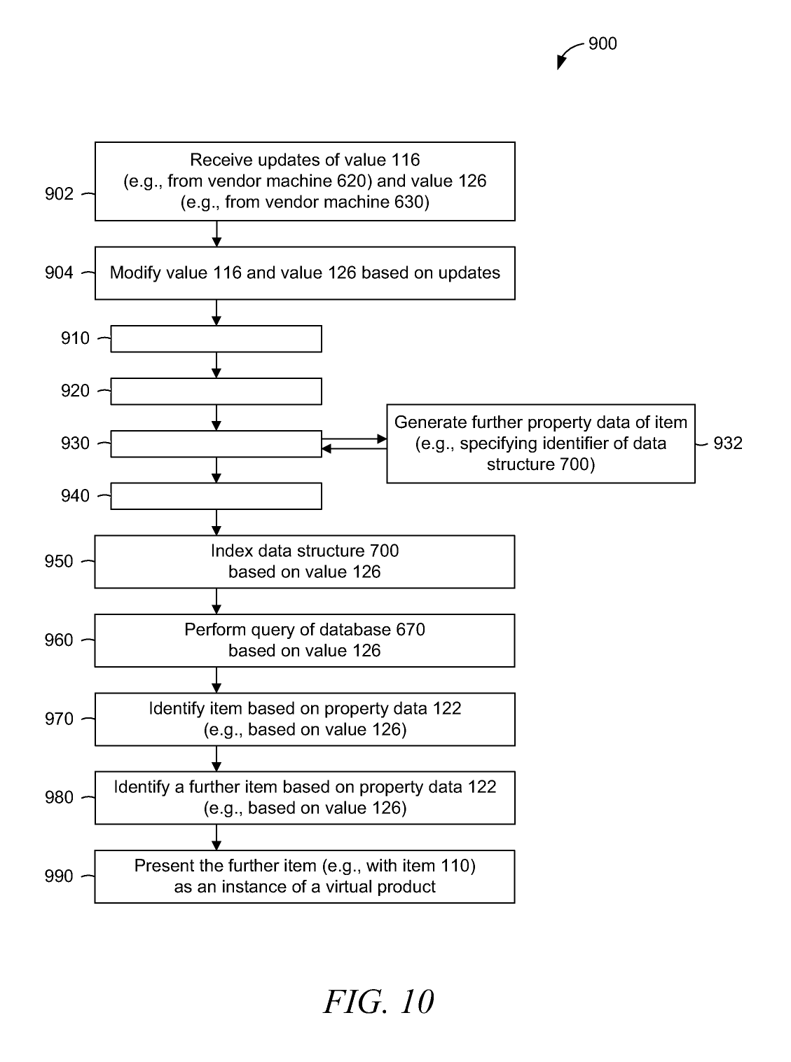

In an example of method 900 shown in FIG. 10, the property data 112 and 122 may already be generated (e.g., stored in the database 670), although the data structure 700 is not necessarily generated yet (e.g., as a result of a previous execution of the method 900). Specifically, the values 116 and 126 may be subject to potential modification (e.g., updating).

Operation 902 involves receiving an update of the value 116 and an update of the value 126, and the operation 902 may be performed by the access module 810. As an example, the access module 810 may receive the update of the value 116 from the vendor machine 620, and may receive the update of the value 126 from the vendor machine 630. In operation 904, the generator module 820 modifies the value 116 and modifies the value 126, based on the updates received in operation 902 by the access module 810.

As shown in FIG. 10, operations 910-940 are to be executed subsequent to operation 904. The operations 910-940 may be performed as described above with respect to FIG. 9.

In operation 932, the generator module 820 generates further property data of the item 110. The further property data may specify an identifier of the data structure 700 (e.g., an item number or a product number), and this identifier may be communicated (e.g., by the generator module 820) to any one or more of the machines shown in FIG. 6. As a result, information received by the access module 810 in operation 902 (e.g., in a subsequent execution of the method 900) may be identified by the access module 810 as being directed to the data structure 700, which corresponds to the item 110. This may have the effect of enabling different entities (e.g., using the vendor machines 620 and 630, the manufacturer machine 640, the information service machine 650, or the client machine 660) to individually and separately submit an update for the data structure 700.

In operation 950, the search module 830 indexes the data structure 700 based on the value 126. The search module 830, in operation 960, performs a query of the database 670 based on the value 126 (e.g., in response to a search request), and in operation 970 identifies the item 110 based on some or all of the property data 122 (e.g., based on the value 126).

In operation 980, the recommendation module 840 identifies a further item based on some or all of the property data 122 (e.g., based on the value 126). The recommendation module 840, in operation 990, presents the further item as an instance of a virtual product. In some example embodiments, the recommendation module 840 also presents the item 110 as an instance of the same virtual product. In certain example embodiments, the recommendation module 840 presents the item 110 as an instance of a product that is related to the virtual product. Alternatively, the recommendation module 840 may present the item 110 as an instance of a project that is unrelated to the virtual product (e.g., as a serendipitous recommendation).

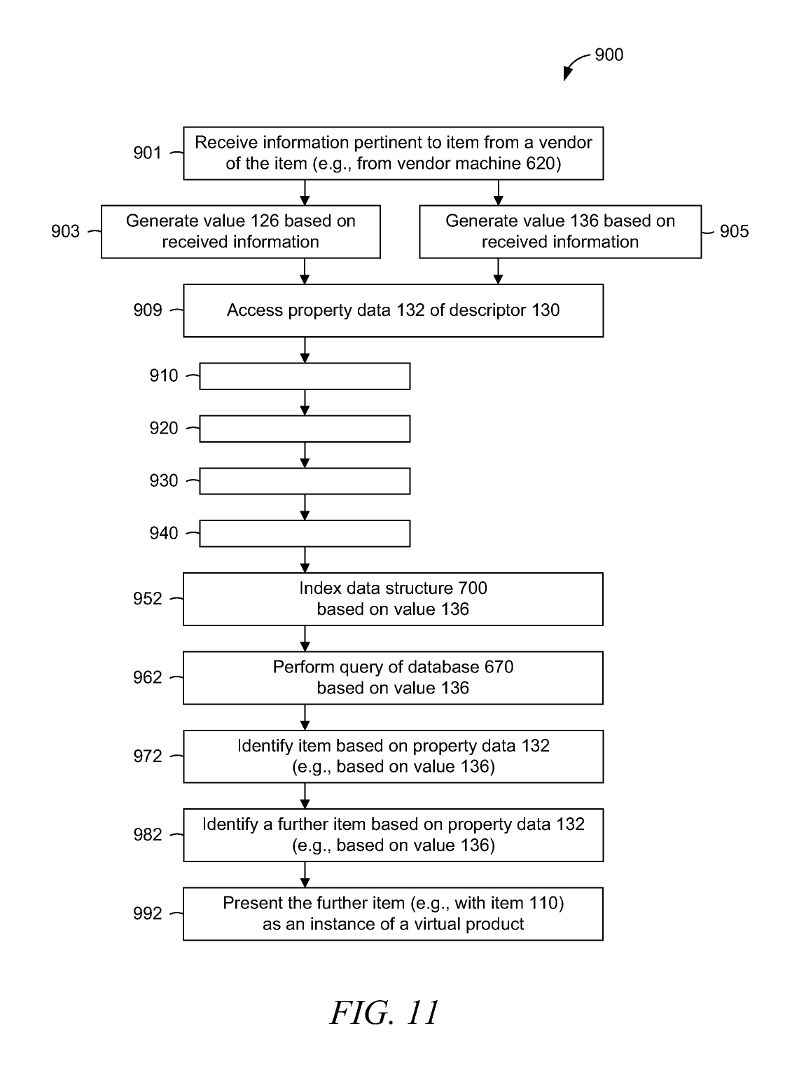

In an example of method 900 shown in FIG. 11, the property data 122 and 132 is not necessarily generated yet, and the data structure 700 is not necessarily generated yet (e.g., as a result of a previous execution of the method 900). Specifically, the values 126 and 136 may be subject to potential generation (e.g., creation or modification).

Operation 901 may be performed by the access module 810 and involves receiving information pertinent to the item 110 from a vendor of the item 110 (e.g., from the vendor machine 620). In operation 903, the generator module 820 generates the value 126 based on the information received in operation 901. Similarly, in operation 905, the generator module 820 generates the value 136 based on the received information.

In operation 909, the generator module 820 accesses the property data 132 of the descriptor 130. The property data 132 specifies the value 136 generated in operation 905.

As shown in FIG. 11, operations 910-940 are to be executed subsequent to operation 909. The operations 910-940 may be performed as described above with respect to FIG. 9 or FIG. 10.

In operation 952, the search module 830 indexes the data structure 700 based on the value 136. The search module 830, in operation 962, performs a query of the database 670 based on the value 136 (e.g., in response to a search request), and in operation 972 identifies the item 110 based on some or all of the property data 132 (e.g., based on the value 136).

In operation 982, the recommendation module 840 identifies a further item based on some or all of the property data 132 (e.g., based on the value 136). The recommendation module 840, in operation 992, presents the further item as an instance of a virtual product. In some example embodiments, the recommendation module 840 also presents the item 110 as an instance of the same virtual product. In certain example embodiments, the recommendation module 840 presents the item 110 as an instance of a product that is related to the virtual product. Alternatively, the recommendation module 840 may present the item 110 as an instance of a product that is unrelated to the virtual product (e.g., as a serendipitous recommendation).

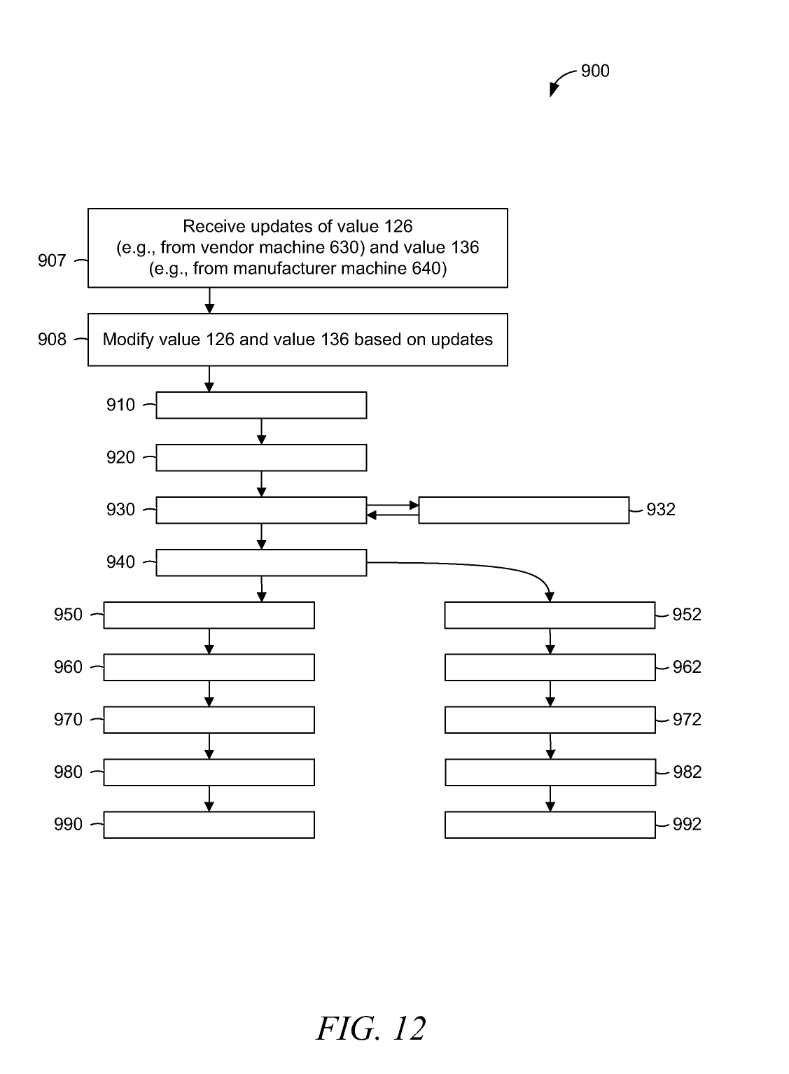

In an example of method 900 shown in FIG. 12, the property data 122 and 132 may be already generated (e.g., stored in the database 670), although the data structure 700 is not necessarily generated yet. Specifically, the values 126 and 136 may be subject to potential modification (e.g., updating).

Operation 907 involves receiving an update of the value 126 and an update of the value 136, and the operation 907 may be performed by the access module 810. As an example, the access module 810 may receive the update of the value 126 from the vendor machine 630, and may receive the update of the value 136 from the manufacturer machine 640. In operation 908, the generator module 820 modifies the value 126 and modifies the value 136, based on the updates received in operation 907 by the access module 810.

As shown in FIG. 12, operations 910-940 are to be executed subsequent to operation 908. The operations 910-940 may be performed as described above with respect to FIG. 9, 10, or 11.

Moreover, as shown in FIG. 12, operations 932, 950, 960, 970, 980, and 990 may be performed as described above with respect to FIG. 10, and operations 952, 962, 972, 982, and 992 may be performed as described above with respect to FIG. 11.

According to various example embodiments, one or more of the methodologies described herein may facilitate the provision of recommendations for products, items, or both, to a user (e.g., of the client machine 660). This may have the effect of providing recommendations that are perceived by the user as being enhanced (e.g., more interesting, more unexpected, or more instructive) compared to existing recommendation technology. Provision of such enhanced recommendations may therefore result in a reduction in search time spent by the user in identifying a desirable item or product. Accordingly, one or more of the methodologies discussed herein may have the technical effect of reducing demand for one or more computing resources used by one or more devices within the system 100 (e.g., the client machine 660). Examples of such computing resources include processor cycles, network traffic, memory usage, storage space, power consumption, and cooling capacity.

FIG. 13 illustrates components of a machine 1300, according to some example embodiments, that is able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system and within which instructions 1324 (e.g., software) for causing the machine 1300 to perform any one or more of the methodologies discussed herein may be executed. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a peer-to-peer (or distributed) network environment. The machine 1300 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1324 (sequentially or otherwise) that specify actions to be taken by that machine. Further, while only a single machine is illustrated, the term “machine” shall also be taken to include a collection of machines that individually or jointly execute the instructions 1324 to perform any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The machine 1300 may further include a graphics display 1310 (e.g., a plasma display panel (PDP), a liquid crystal display (LCD), a projector, or a cathode ray tube (CRT)). The machine 1300 may also include an alphanumeric input device 1312 (e.g., a keyboard), a cursor control device 1314 (e.g., a mouse, a touchpad, a trackball, a joystick, a motion sensor, or other pointing instrument), a storage unit 1316, a signal generation device 1318 (e.g., a speaker), and a network interface device 1320.

The storage unit 1316 includes a machine-readable medium 1322 on which is stored the instructions 1324 (e.g., software) embodying any one or more of the methodologies or functions described herein. The instructions 1324 may also reside, completely or at least partially, within the main memory 1304, within the processor 1302 (e.g., within the processor's cache memory), or both, during execution thereof by the machine 1300. Accordingly, the main memory 1304 and the processor 1302 may be considered as machine-readable media. The instructions 1324 may be transmitted or received over a network 1326 (e.g., network 190) via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., software) for execution by the machine, such that the instructions, when executed by one or more processors of the machine (e.g., processor 1302), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing property data of an item, the property data of the item specifying a first attribute and a first value that is assignable to the first attribute, the first value specifying a characteristic of the item;
accessing property data of the characteristic of the item, the property data of the characteristic specifying a second attribute and a second value that is assignable to the second attribute, the second value specifying a descriptor of the characteristic;
generating a data structure based on the property data of the item and based on the property data of the characteristic, the data structure indicating that the characteristic corresponds to the item and that the descriptor corresponds to the characteristic of the item, the generating of the data structure being performed by a module implemented using a processor of a machine; and
storing the generated data structure in a database as a composite of property data pertinent to the item.

2. The method of claim 1 further comprising:
indexing the generated data structure based on the second value;
performing a query of the database, the query being based on the second value; and
identifying the item based on the second value.

3. The method of claim 2, wherein:
the item is an instance of a first product available for purchase; and the method further comprises:
identifying a further item based on the second value, the further item being an instance of a second product available for purchase; and
presenting the further item as an instance of a third product available for purchase, the third product being associated with the descriptor of the characteristic, the third product corresponding to the second value.

4. The method of claim 1, wherein:
the generating of the data structure includes generating further property data of the item, the further property data specifying an identifier of the data structure, and the method further comprises
receiving updates of the first value and of the second value from different machines, each of the updates specifying the identifier of the data structure; and
modifying the first value and the second value based on the received updates.

5. The method of claim 1 further comprising:
accessing property data of the descriptor, the descriptor being of the characteristic of the item, the property data of the descriptor specifying a third attribute and a third value that is assignable to the third attribute, the third value specifying a feature of the descriptor; wherein
the generating of the data structure is based on the property data of the descriptor, the data structure indicating that the feature corresponds to the descriptor of the characteristic of the item.

6. The method of claim 5 further comprising:
indexing the generated data structure based on the third value;
performing a query of the database, the query being based on the third value; and
identifying the item based on the third value.

7. The method of claim 6, wherein:
the item is an instance of a first product available for purchase; and the method further comprises:
identifying a further item based on the third value, the further item being an instance of a second product available for purchase; and
presenting the further item as an instance of a third product available for purchase, the third product being associated with the feature of the descriptor, the third product corresponding to the third value.

8. The method of claim 5, wherein:
the property data of the product includes a first name-value pair that specifies the first attribute and the first value;
the property data of the characteristic includes a second name-value pair that specifies the second attribute and a second value; and
the property data of the descriptor includes a third name-value pair that specifies the third attribute and the third value.

9. The method of claim 5 further comprising:
receiving information pertinent to the item from a vendor of the item; and
generating the third value based on the received information.

10. The method of claim 5, wherein:
the generating of the data structure includes generating further property data of the item, the further property data specifying an identifier of the data structure, and the method further comprises
receiving updates of the second value and of the third value from different machines, each of the updates including the identifier of the data structure; and
modifying the generated data structure based on the received updates and based on the identifier being included in each of the received updates.

11. The method of claim 1 further comprising:
receiving information pertinent to the item from a vendor of the item; and
generating the second value based on the received information.

12. A system comprising:
an access module configured to:
access property data of an item, the property data of the item specifying a first attribute and a first value that is assignable to the first attribute, the first value specifying a characteristic of the item; and
access property data of the characteristic of the item, the property data of the characteristic specifying a second attribute and a second value that is assignable to the second attribute, the second value specifying a descriptor of the characteristic; and
a generator module implemented using a processor of a machine, the generator module being configured to:
generate a data structure based on the property data of the item and based on the property data of the characteristic, the data structure indicating that the characteristic corresponds to the item and that the descriptor corresponds to the characteristic of the item; and
store the generated data structure in a database as a composite of property data pertinent to the item.

13. The system of claim 12 further comprising:
a search module configured to:
index the generated data structure based on the second value;
perform a query of the database, the query being based on the second value; and
identify the item based on the second value.

14. The system of claim 13, wherein:
the item is an instance of a first product available for purchase; and the system further comprises
a recommendation module configured to:
identify a further item based on the second value, the further item being an instance of a second product available for purchase; and
present the further item as an instance of a third product available for purchase, the third product being associated with the descriptor of the characteristic, the third product corresponding to the second value.

15. The system of claim 12, wherein:
the access module is configured to access property data of the descriptor, the descriptor being of the characteristic of the item, the property data of the descriptor specifying a third attribute and a third value that is assignable to the third attribute, the third value specifying a feature of the descriptor; and
the generator module is configured to generate the data structure based on the property data of the descriptor, the data structure indicating that the feature corresponds to the descriptor of the characteristic of the item.

16. The system of claim 15 further comprising:
a search module configured to:
index the generated data structure based on the third value;
perform a query of the database, the query being based on the third value; and
identify the item based on the third value.

17. The system of claim 16, wherein:
the item is an instance of a first product available for purchase; and the search module is configured to:
identifying a further item based on the third value, the further item being an instance of a second product available for purchase; and
presenting the further item as an instance of a third product available for purchase, the third product being associated with the feature of the descriptor, the third product corresponding to the third value.

18. The system of claim 12, wherein:
the access module is configured to receive information pertinent to the item from a vendor of the item; and
the generator module is configured to generate the second value based on the received information.

19. A non-transitory machine-readable storage medium comprising instructions that, when executed by one or more processors of a machine, cause the machine to perform a method comprising:
accessing property data of an item, the property data of the item specifying a first attribute and a first value that is assignable to the first attribute, the first value specifying a characteristic of the item;
accessing property data of the characteristic of the item, the property data of the characteristic specifying a second attribute and a second value that is assignable to the second attribute, the second value specifying a descriptor of the characteristic;
generating a data structure based on the property data of the item and based on the property data of the characteristic, the data structure indicating that the characteristic corresponds to the item and that the descriptor corresponds to the characteristic of the item; and
storing the generated data structure in a database as a composite of property data pertinent to the item.

20. The non-transitory machine-readable storage medium of claim 19, wherein the method further comprises:
accessing property data of the descriptor, the descriptor being of the characteristic of the item, the property data of the descriptor specifying a third attribute and a third value that is assignable to the third attribute, the third value specifying a feature of the descriptor; wherein
the generating of the data structure is based on the property data of the descriptor, the data structure indicating that the feature corresponds to the descriptor of the characteristic of the item.
